(19) United States
(12) Patent Application Publication
(10) Pub. No.: US 2022/0371632 A1
(43) Pub. Date: Nov. 24, 2022

(54) WHEELSET BEARING FOR A RAIL VEHICLE AND METHOD FOR OPERATING A SENSOR SYSTEM OF A WHEELSET BEARING

(71) Applicant: SCHAEFFLER TECHNOLOGIES AG & CO. KG, Herzogenaurach (DE)

(72) Inventors: Sebastian Pachner, Veitshochheim (DE); Bert Rosenheinrich, Dittelbrunn (DE); Michael Holzapfel, Heidenheim (DE)

(73) Assignee: SCHAEFFLER TECHNOLOGIES AG & CO. KG, Herzogenaurach (DE)

(21) Appl. No.: 17/601,692

(22) PCT Filed: Dec. 9, 2019
(86) PCT No.: PCT/DE2019/101057

§ 371 Date: Jul. 27, 2022

(30) Foreign Application Priority Data
Apr. 5, 2019 (DE) 10 2019 108 981.6

(51) Int. Cl. B61F 15/20; B61D 43/00; F16C 41/00

(52) U.S. Cl. CPC B61F 15/20; B61D 43/00; F16C 41/00

(57) ABSTRACT

A wheelset bearing for a rail vehicle has a generator which is designed as a claw-pole generator, which includes at least one non-rotating claw ring, as well as a sensor system supplied with electrical energy by the generator The sensor system has a plurality of sensor system modules which are at least partially fastened to a sensor carrier placed on the claw ring and which are connected to a common data line.

### CROSS-REFERENCE TO RELATED APPLICATIONS

This application is the U.S. National Phase of PCT Appln. No. PCT/DE2019/101057 filed Dec. 9, 2019, which claims priority to DE102019108981.6 filed Apr. 5, 2019, the entire disclosures of which are incorporated by reference herein.

### TECHNICAL FIELD

The disclosure relates to a wheelset bearing which is provided for operation in a rail vehicle and which comprises a generator and a sensor system operated with the aid of the generator. The disclosure also relates to a method for operating a sensor system of a wheelset bearing of a rail vehicle.

### BACKGROUND

From AT 507 382 A1 a wheelset bearing housing with a position detection device for a rail vehicle is known. To power the position detection device, a generator is provided, which has a rotor that can be driven by a wheelset shaft rotatably mounted in the wheelset bearing housing. The associated stator of the generator is mounted on the inside of a cover of the wheelset bearing housing. Overall, the electrical generator is designed as a hub generator without bearings.

DE 10 2006 035 703 A1 discloses a device for monitoring at least one operating variable of a wheelset bearing of a rail vehicle. In this case, an electrical generator comprises a Wiegand element as a generator element rotating with a shaft.

### SUMMARY

The object of the disclosure is to specify further developed possibilities of attaching and operating sensor systems in a wheelset bearing of a rail vehicle compared with the prior art mentioned.

This object is achieved according to the disclosure by a wheelset bearing designed for use in a rail vehicle having the features described herein. The object is also achieved by a method for operating a sensor system of a wheelset bearing according to the disclosure. The configurations and advantages of the disclosure explained below in connection with the operating method also apply analogously to the device, i.e., the wheelset bearing, and vice versa.

The wheelset bearing comprises a generator which is designed as a claw-pole generator, which has a non-rotating claw ring, as well as a sensor system which is supplied with electrical energy by the claw-pole generator, which comprises multiple sensor system modules, which are at least partially attached to a sensor carrier placed on the claw ring and connected to a common data line.

Different claw-pole generators are known in principle from the documents DE 10 2010 021 160 A1 and EP 2 572 114 A1. In these cases, two claw-pole generators are integrated in a rolling bearing.

Another rolling bearing with an integrated claw-pole generator is described in DE 10 2014 207 209 A1, in which case magnetically conductive claws are only arranged in sections along the circumference of a bearing ring of the rolling bearing.

In the case of the wheelset bearing according to the disclosure, the sensor carrier either completely or only partially covers the annular disc-shaped claw ring. In any case, by attaching the sensor carrier to the claw ring, a space-saving arrangement of the sensor system modules within the wheelset bearing is possible. The claw-pole generator can comprise either a single claw ring or a plurality of claw rings, in particular two claw rings, wherein, in the latter case, both claw rings are preferably located on the same end face of the rolling bearing of the wheelset bearing.

The sensor carrier is either attached directly to the claw ring or attached to another non-rotating part of the wheelset bearing. The claw ring itself can also be used as a sensor carrier. In any case, the sensor carrier lies in a plane which is parallel to the plane in which the claw ring lies. In a preferred embodiment, the sensor carrier protrudes neither inward nor outward beyond the claw ring in the radial direction. In the circumferential direction of the claw ring, the sensor carrier preferably extends over an arc of no more than 180 degrees, in particular over an angle of 90 degrees at most.

The sensor system modules, which are arranged on the sensor carrier, are selected depending on the requirements of the individual case and are easily exchangeable, wherein the common data line to which the sensor system modules are to be connected contributes significantly to the production-friendly, versatile, configurable structure of the sensor system. In a particularly preferred embodiment, the common data line also supplies energy to the sensor system modules, at least insofar as they are arranged on the sensor carrier.

The method for operating the sensor system of the wheelset bearing is generally characterized in that electrical energy is generated by means of a claw-pole generator, which comprises a non-rotating claw ring, and used to operate a sensor system comprising multiple sensor system modules arranged at least partially on the claw pole generator within an annular space, and wherein data supplied by the sensor system modules is transmitted via a line which also serves as a power supply line.

The sensor system modules arranged on the sensor carrier are designed, for example, for spatial resolution, temperature measurement, acceleration measurement and/or for detecting the presence and possibly the properties of lubricant. As far as spatially resolving sensor system modules are concerned, these can in principle be designed as incremental or absolute sensors. A spatially resolving sensor can be integrated into an odometry system, wthich is a system for estimating the position using a propulsion system. The same spatially resolving sensor or a separate sensor can be used as a speed sensor.

Examples of accelerations sensors in different applications are described in the documents DE 10 2017 121 010 A1 and DE 10 2017 112 029 B3. With regard to lubricant sensors, reference is made to the technical background in the documents DE 10 2013 211 486 A1 and DE 10 2010 015 722 A1.

According to possible developments, spatially separated from the sensor carrier, which is positioned on the claw ring, a compression sensor and/or a force sensor are integrated into the sensor system of the wheelset bearing. The force sensor is in the form of a strain gauge, for example, which is arranged on the outer ring of a rolling bearing ring of the wheelset bearing that is stationary relative to the claw ring.

In all cases, the claw-pole generator integrated in the wheelset bearing provides an uninterruptible power supply for the sensor system, which supplies electrical energy as soon as the rail vehicle moves. Optionally, the claw-pole generator is coupled to an energy store, for example in the form of an accumulator and/or capacitor, in order to maintain the energy supply of the sensor system for a limited time, even when the rail vehicle is at a standstill. The energy supplied by the claw-pole generator can also be used for wireless transmission of data that was detected by the sensors.

### BRIEF DESCRIPTION OF THE DRAWINGS

In the following, an exemplary embodiment of the disclosure is explained in more detail by means of a drawing. In the figures:

FIG. 1 shows a perspective view of a housing cover of a wheelset bearing including various different sensor components,

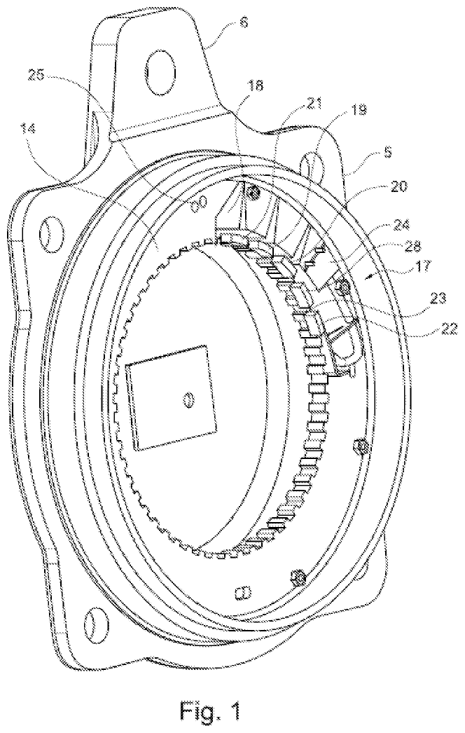

FIG. 2 shows the wheelset bearing including the housing cover in a sectional view.

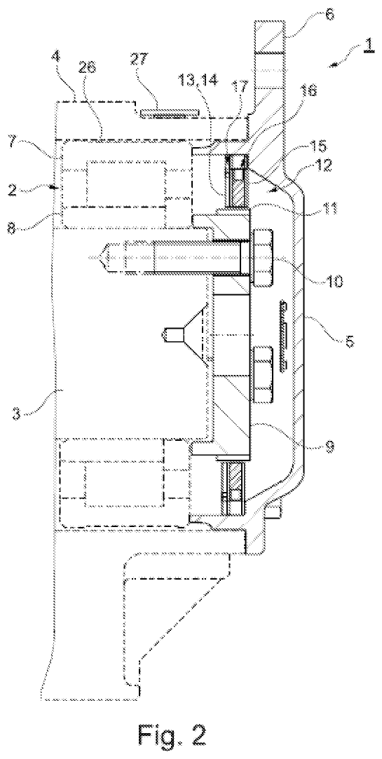

### DETAILED DESCRIPTION

A wheelset bearing identified overall with the reference number 1 is intended for use in a rail vehicle and comprises a rolling bearing 2, namely a roller bearing, with which a wheelset shaft 3 is mounted in a housing 4 of the wheelset bearing 1. The housing 4 is closed by a housing cover 5. A fastening tab of the housing cover 5 is denoted by 6. The outer ring, denoted by 7, of the rolling bearing 2 is received in the housing 4. The inner ring of the rolling bearing 2, denoted by 8 and held on the wheelset shaft 3, is the rotating bearing ring of the rolling bearing 2. The inner ring 8 makes contact with an end cap 9, which is attached to the end face of the wheelset shaft 3 with the aid of screws 10. On the end cap 9 there is a magnetic tape 11, which can be assigned to a claw-pole generator 12.

The magnetic tape 11 rotating during operation of the wheelset bearing 1, on the circumference of which there are magnetic poles with alternating polarity, interacts with a stator 13 of the claw-pole generator 12 attached in the housing 4. The stator 13 comprises a coil body made of glass fiber-reinforced plastic and two mutually parallel claw rings 14, 15, between which there is a coil winding 16 made of copper. The claw rings are deep-drawn and stamped sheet metal parts. The claw ring 14 carries a sensor system 17, which will be discussed in more detail below. The claw rings 14, 15 are also referred to as claw sheets.

A sensor carrier 18 is placed directly on the claw ring 14 and extends arcuately over part of the circumference of the claw ring 14. Among other things, an odometry sensor 19 and a speed sensor 20 are attached to the sensor carrier 18 as spatially resolving sensor system modules 19, 20. A temperature sensor 21, an acceleration sensor 22 and a lubricant sensor 28 are held on the sensor carrier 18 as ftirther sensor system modules. The sensor system modules 19, 20, 21, 22, 28 are connected to a common line 23. An associated level converter is denoted by 24. The line 23 is designed to both transmit data and to supply the entire sensor system 17 with energy via the claw-pole generator 12. Cable bushings for the sensor system 17 in the claw ring 14 are denoted by 25.

In addition to the sensor system modules 19, 20, 21, 22, 28 attached to the sensor carrier 18, the sensor system 17 comprises two sensors 26, 27 spaced from the sensor carrier 18, namely a compression sensor 26 and a force sensor 27. The compression sensor 26 is located on the outer ring 7 of the rolling bearing 2. The force sensor 27 is a strain gauge attached to the outside of the housing 4. The sensors 26, 27 are also linked in terns of data technology via the line 23 or separate lines to those sensor system modules 19, 20, 21, 22, 28 that are located on the sensor carrier 18. As a circuit board connected to the claw ring 14, the sensor carrier 18 is an integral part of the claw-pole generator 12.

List of reference symbols

1 Wheel set bearing

2 Rolling bearing

3 Wheelset shaft

4 Housing

5 Housing cover

6 Fastening tab

7 Outer ring

8 Inner ring

9 End cap

10 Screw

11 Magnetic tape

12 Claw-pole generator

13 Stator

14 Claw ring

15 Claw ring

16 Coil winding

17 Sensor system

18 Sensor carrier

19 Odometry sensor

20 Speed sensor

21 Temperature sensor

22 Acceleration sensor

23 Line

24 Level converter

25 Cable bushing

26 Compression sensor

27 Force sensor

28 Lubricant sensor

1. A wheelset bearing for a rail vehicle, a generator configured as a claw-pole generator that includes at least one non-rotating claw ring and a sensor system which is supplied with electrical energy by the generator, which comprises a plurality of sensor system modules at least some of which are attached to a sensor carrier placed onto the claw ring and connected to a common data line.

2. The wheelset bearing according to claim 1, wherein the sensor system comprises at least one spatially resolving sensor system module.

3. The wheelset bearing according to claim 2, wherein the spatially resolving sensor system module is part of an odometry system.

4. The wheelset bearing according to claim 2, the spatially resolving sensor system comprises a speed sensor.

5. The wheelset bearing according to 4claim 1, wherein a temperature sensor is provided as a sensor system module fastened to the sensor carrier.

6. The wheelset bearing according to claim 1, wherein an acceleration sensor is provided as a sensor system module fastened to the sensor carrier.

7. The wheelset bearing according to claim 1, wherein a lubricant sensor is provided as a sensor system module fastened to the sensor carrier.

8. The wheelset bearing according to claim 1, wherein the sensor system comprises a compression sensor spaced apart from the sensor carrier.

9. The wheelset bearing according to claim 1, wherein the sensor system comprises a force sensor in a form of a strain gauge spaced apart from the sensor carrier, wherein the strain gauge is arranged on an outer ring of a rolling bearing ring which is stationary relative to the claw ring. 10. A method for operating a sensor system of a wheelset bearing of a rail vehicle, the method comprising: generating electrical energy by a claw-pole generator, which comprises a non-rotating claw ring, and operating a sensor system comprising a plurality of sensor system modules arranged at least partially on the claw pole generator within an annular space, and transmitting data supplied by the sensor system modules via a line configured to serve as a power supply line.

11. A method for operating a sensor system of a wheelset bearing of a rail vehicle, comprising:
arranging one or more of a plurality of sensor system modules on a claw-pole generator comprising the wheelset bearing;
generating electrical energy by means of the claw-pole generator; and
transmitting the electric energy to the sensor system modules by means of a power supply line.

12. The method of claim 11, wherein arranging includes attaching at least one of the plurality of sensor system modules to a sensor carrier.

13. The method of claim 12, wherein attaching includes placing the sensor carrier onto a non-rotating claw ring.

14. The method of claim 13, wherein attaching includes connecting the sensor carrier to the power supply line.

15. The method of claim 11, wherein transmitting includes transmitting data supplied by the sensor system modules by way of the power supply line.

16. The method of claim 11, wherein generating includes transmitting electrical energy to the sensor system modules by way of the power supply line.
